(19) United States
(12) Patent Application Publication
(10) Pub. No.: US 2007/0100657 A1
(43) Pub. Date: May 3, 2007

(54) System of products having complimentary outer surface contours and indicia

(75) Inventors: Murphy Greene Mongeon, Baltimore, MD (US); Donald Wilfred Robert Williams, London (GB); Amy Bridgman, London (GB); George Scott Kerr, Mason, OH (US); Daphne Grace Hine, Wallington (GB); Gregory Christopher Peischl, Mason, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/591,115

(22) Filed: Nov. 1, 2006

Related U.S. Application Data
(60) Provisional application No. 60/733,060, filed on Nov. 3, 2005.

(51) Int. Cl. G06Q 99/00

(52) U.S. Cl. 705/1

(57) ABSTRACT

The present invention is directed to a system comprising two or more products wherein each product comprises complimentary outer surface contours which are mutually engagable in intimate contact to the other product and wherein each product comprises an indicia that extends across each product and communicates that the products are a system.

### CROSS REFERENCE TO RELATED APPLICATIONS

This application claims the benefit of U.S. Provisional application Ser. No. 60/733,060, filed on Nov. 3, 2005.

### FIELD OF THE INVENTION

The present invention relates to a system comprising two or more products comprising complimentary outer surface contours which are mutually engagable in intimate contact, and more particularly, relates to such a system wherein each product comprises an indicia that extends across each product and communicates that the products are a system.

### BACKGROUND OF THE INVENTION

Effective and eye catching packaging for containing and displaying products on shelves of retail outlets has long been a goal of product manufacturer in order to make the product brand and its packaging distinct and memorable for consumers. Virtually endless variations of product containers have been developed over the years. Most successful products containers are designed to attract attention of passing consumers. In the retail world, “POP” is used to refer to point-of-purchase advertising displays. POP displays can take various forms and it has been reported that an estimated percentage of purchase decisions are made within the retail store itself. Therefore, effective POP displays may have an impact on sales for a particular product category or brand. As well, many product containers have been designed with physical features that provide consumers with a pleasant, distinct, and memorable experience while the product is being used. This will provide a positive incentive for the consumer to re-purchase the product.

Such a display would be uniquely attracting to passing consumers and thus would lead inexorably to increased sales of the brand of product sold in the container. As well, the repeated exposure of the consumer to the unique elements of the product during the use of the product may lead to making a brand and a product more distinct and memorable.

However, there has been a need for a packaging system to signal to the consumer on shelf that a system set can provide a complimentary benefit and/or complimentary efficacy when the consumer purchases the system.

Accordingly, the present invention is directed to providing a system comprising two or more products wherein each product comprises complimentary outer surface contours so as to be mutually engagable in intimate contact to the other product and wherein each product comprises an indicia that extends across each product and communicates that the products are operating as a system or denotes or designate a system.

### SUMMARY OF THE INVENTION

The present invention discloses a system comprising two or more products wherein each product comprises complimentary outer surface contours which are mutually engagable in intimate contact to the other product and wherein each product comprises an indicia that extends across each product and communicates that the products are a system.

### BRIEF DESCRIPTION OF THE DRAWINGS

FIG. 1 is a graph demonstrating the use of a PTZ containing shampoo, the use of a PTZ shampoo plus a platelet PTZ conditioner, and the use of a PTZ shampoo plus a non-PTZ conditioner as indexed to a PTZ shampoo.

### DETAILED DESCRIPTION OF THE INVENTION

While the specification concludes with claims which particularly point out and distinctly claim the invention, it is believed the present invention will be better understood from the following description.

The present invention can comprise, consist of, or consist essentially of the essential elements and limitations of the invention described herein, as well any of the additional or optional ingredients, components, or limitations described herein.

All percentages, parts and ratios are based upon the total weight of the compositions of the present invention, unless otherwise specified. All such weights as they pertain to listed ingredients are based on the active level and, therefore, do not include carriers or by-products that may be included in commercially available materials.

The components and/or steps, including those which may optionally be added, of the various embodiments of the present invention, are described in detail below.

All documents cited are, in relevant part, incorporated herein by reference; the citation of any document is not to be construed as an admission that it is prior art with respect to the present invention.

All ratios are weight ratios unless specifically stated otherwise.

All temperatures are in degrees Celsius, unless specifically stated otherwise.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”

Herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

Herein, “effective” means an amount of a subject active high enough to provide a significant positive modification of the condition to be treated. An effective amount of the subject active will vary with the particular condition being treated, the severity of the condition, the duration of the treatment, the nature of concurrent treatment, and like factors.

An embodiment of the present invention is directed to developing a cosmetically efficacious package by communicating system effectiveness while providing other system benefits. These benefits reinforce the brand character and strategic equity. More specifically, an embodiment of the present invention is to improve the communication to the consumer that two or more products comprising cosmetically efficacious packaging may operate as a system wherein the consumer is signaled to obtain the system to obtain product effectiveness and/or efficiency while providing other system benefits. Without being bound by theory, it is believed that by providing a more clear communication to a consumer on-shelf of a system that provides product effectiveness and/or efficiency or enhanced efficacy, may result in an improved and more effective experience for the consumer when the consumer uses the system. Such an improvement in the use of this system may then result in improved consumer satisfaction and provide a positive incentive for the consumer to re-purchase the product.

In an embodiment, the present invention may include, but is not limited to a cosmetically efficacious system communicating a system or brand system effectiveness (for example, but not limited to, dandruff control, moisturization, anti-aging etc.) while providing other system benefits (for example, but not limited to, cosmetic hair benefits such as volumizing, smoothing, anti-frizz control or cosmetic skin benefits such as smoothing, wrinkle reduction, fine lines, and uneven skin texture).

A further embodiment would be wherein the present invention provides a consumer connection to the brand and product via the package system wherein the package design communicates to the consumer that the product is correct for them. Some examples may include, but are not limited to, a shampoo and a conditioner system wherein the system of products communicates to a consumer on both style and functionality; a body wash and a skin moisturization system wherein the system of products communicates to a consumer on both cleansing and moisturization; a laundry detergent and a laundry softener system wherein the system of products communicates both cleansing and softening; an oral care tooth paste and a mouthwash system wherein the system of products communicates both cleansing and oral hygiene.

In an embodiment of the present invention, a pair of products, provide complimentary outer surface contours so as to be mutually engagable in intimate contact. In one embodiment of the present invention, a pair of products have an outer surface contour, so that the two products are mutually engagable in intimate contact. A nonlimiting example is shown in Example 1.

In an embodiment of the present invention, a pair of products, provide complimentary outer surface contours so as to be mutually engagable in intimate contact. In one embodiment of the present invention, a pair of products have an outer surface contour, so that the two products are mutually engagable in intimate contact and further wherein each product comprises an indicia that extends across each product and communicates that the products are a system. Nonlimiting examples are shown in Examples 2, 3 and 4.

A further embodiment of the present invention comprises a pair of products wherein the outer surface contours of the products are complimentary when one of the containers is inverted, and providing the complimentary outer surface contours so as to be mutually engagable in intimate contact.

Another embodiment of the present invention, is to provide a system comprising two or more products wherein each product comprises complimentary outer surface contours so as to be mutually engagable in intimate contact to the other product, for convenience when the contents of the containers provide complimentary substances. Non-limiting examples of this embodiment would be hair shampoo and hair conditioner, personal care body wash and personal care body conditioner, laundry detergent and laundry softener, and toothpaste and mouthwash.

An embodiment of the present invention involves a system having two or more products wherein the system communicates one or more performance characteristics. The system performance characteristic may include, but is not limited to, the product form, benefit of the system, efficacy level, fragrance level, performance level, and the like. With respect to a shampoo and conditioner system, the system performance characteristic may include, but is not limited to, the system form, benefit of the system such as shine benefit, volume benefit, smooth and straight benefit, efficacy such as anti-dandruff efficacy or moisturization efficacy, the level of protection such as color enhancement, and fragrance benefit.

In a further embodiment, the system may comprise two or more products wherein the two products are identified by an identifier selected from the group consisting of packaging, color of packaging, shelf marking and mixtures thereof. Unless stated otherwise, packaging may include primary packaging, secondary packaging, and mixtures thereof. In a further embodiment, two or more products that comprise a system may further include an identifier that is an indicia. The term “indicia,” as used herein, relates to identifying markings, which may include, for example, words and/or graphics. Nonlimiting examples includes indicia of the system extending across two or more products describing a product or system in use or describing a product or system characteristic or product benefit.

The indicia of the system of consumer products may be synergistic such that when they are displayed or packaged in a unitary form, a consumer knows that the two products should be purchased and/or used in conjunction with each other. The synergistic identifiers together communicate to a consumer that the two or more products of the present invention should be bought and/or used in relation to each other.

Synergistic packaging of the present invention may physically or visually interact by a means selected from the group consisting of interlocking, nesting, mating, co-operative assembly, connection, and a complimentary outer surface reflected along a straight line to form a third geometry or third shape. As used herein, “interlocking”describes a connection between two or more products wherein at least two products are locked together, for instance, a tongue and groove. As used herein, “connection” describes a connection between two or more products other than locking the at least two products together, for instance, bonding. As used herein, “nesting” “mating” or “co-operative assembly” describes the interaction between two or more products wherein at least two products are in simple contact with each other such that the shape of one product conforms to the shape of the other product, for instance, hand in glove or spoon in spoon. As used herein, a complimentary outer surface reflected along a straight line to form a third geometry or third shape as demonstrated, a nonlimiting example is shown in Example 3, 4 and 5. In this embodiment, the complimentary outer surfaces of each product align along each products straight line to form a third geometry which is a hectagon shape.

The synergistic identifiers may also comprise indicia wherein two or more indicias together communicate to the consumer that the two or more products should be bought and/or used in relation to each other. The indicia may be labels selected from a group of labels consisting of complimentary labels, continual labels, sequential labels, adjoining labels, and mixtures thereof. By complimentary labels it is meant that at least two labels are two halves that make a whole, two colors that are the same, and mixtures thereof. For example, the identifiers may be labels comprising artwork wherein the label of the first product comprises the complimentary half of the label of the second product. For example, the first product may have a label comprising a red, left half of a circle while the second product may have a label comprising a red, right half of a circle which may signal to a consumer that the two products should be bought and/or used in conjunction with each other. By continual labels it is meant that the combination of the first and second identifier as a whole creates a complete phrase or a complete picture. Unlike complimentary labels, the artwork depicted on continual labels may not be complimentary first and second halves but rather may be a first part of a picture on the first product that continues as a second part of a picture on the second product. For example, a first product may have a label comprising a picture of a lady walking a dog wherein only the lady and the upper part of a leash are seen. The second product may have a label comprising a picture of a bottom half of a leash and the dog that is being walked by the lady on the first identifier. Thus, there is a continuous picture wherein a consumer can identify the two products as those that may be bought and/or used in relation to each other. Or, for example, a first and second identifier as a whole may spell the word “Brand” wherein the first product has a label comprising the letters “Bra” and the second product has a label comprising the letters “nd” wherein a consumer can identify the products spelling a complete word as those that may be bought and/or used in relation to each other. By sequential labels it is meant that the products may be displayed communicating the order of use or the time of use. For example, the line of products may comprise a first product having a label comprising the word or number one, the second product having a label comprising the word or number two and a third product having a label comprising the word or number three. By adjoining labels, it is meant that the first and second identifier may comprise at least one label that adheres to at least two products and indicate to a consumer that the products should be bought and/or used in relation to each other.

In a further embodiment of the present invention, the synergistic identifiers of the present invention may not only create a system of complimentary products to be sold, bought or packaged together but it may also encourage consumers to follow a regimen of use. A nonlimiting example would be a system of complimentary products, according to the present invention, comprising an antidandruff shampoo and an antidandruff conditioner which communicate to a consumer a regimen of using the two products in order to obtain an efficacious antidandruff benefit. A further nonlimiting example would be a system of complimentary products, according to the present invention, comprising the use of a laundry detergent and a laundry softener in order to obtain an enhanced cleansing and softening benefit of the system in the laundry process.

In a further embodiment, the present invention is directed to a system comprising two or more products wherein each product comprises complimentary outer surface contours so as to be mutually engagable in intimate contact to the other product and wherein each product comprises an indicia that extends across each product and communicates that the products are a system, and further wherein the indicia communicates a version of the system. Non-limiting examples of a system version would be versions for straight hair, wavy hair, curly hair, blonde, brown or red hair, dry hair, and oily hair. Such system versions may directed to a hair type or to an end such as providing volume.

In yet a further embodiment, the present invention is directed to a system comprising two or more products wherein each product comprises complimentary outer surface contours so as to be mutually engageable in intimate contact to the other product are a system, and further wherein the indicia which extend across two or more products communicates a version of the system of two or more products. Non-limiting examples of such a system group or system family benefit examples may be a price tier group, a treatment group such as antidandruff, and a colored hair group.

Additionally, in a further embodiment, the identifiers of the present invention may communicate to the consumer without the additional labor of picking up the system and reading the labels.

A further embodiment of the present invention is directed to the use of a shrink film or shrink sleeve which may be used to achieve the appearance of the system of products as described herein.

The consumer products described herein may include a variety of consumer products including but not limited to antiperspirants, deodorants, hair care products, and personal care products including, but not limited to, body wash, body sprays, lotions, creams, and the like. In a further embodiment, the present invention may be used in the areas of personal care products such as shampoos, conditioners, styling, skin care, and cleansing products, fabric care products, home care products, health care products, baby care products and food products.

A system performance characteristic is the recognition of the execution of a particular characteristic of product. As used herein, the term “characteristic” refers to any distinguishing trait, quality, or properties of the system. Nonlimiting examples of system performance characteristics include hair care benefits such as moisturization, color enhancement, shine, anti-dandruff efficacy, dry scalp efficacy, skin benefits and skin cosmetic benefits. In another embodiment, the system includes at least one label attached to the each product. The label may include indicia disposed thereon and extending across two or more products and relating to at least one performance characteristic of the system of two or more products. The term “label,” as used herein, relates to the tangible medium on which indicia are expressed, including, for example, the placing of indicia directly on and extending across a system of two or more product (for example, printing or molding) or the printing of indicia on a substrate which extends across two or more products wherein the substrate is placed on the outside surface of the system of two or more products.

The indicia element which extends across two or more products in a system may be chosen from a visual indicator or a narrative indicator for the system. In one embodiment, the system of the present invention includes two or more indicia elements which extend across two or more products.

The term “visual indicator,” as used herein, includes any illustration, painting, photograph, drawing, picture, logo, or hologram, that visually communicates or signals system performance characteristics of two or more products.

The term “narrative indicator,” as used herein, includes letters, numbers or combination thereof that communicate or signal system performance characteristics of two or more.

In a further embodiment of the present invention, a system is provided according to the present invention wherein the complimentary outer surface contours form a circular shape.

In a further embodiment of the present invention , a system is provided wherein wherein the complimentary outer surface contours of the products is discontinuous. And yet a further embodiment is wherein the complimentary outer surface contours of the products is discontinuous and further wherein there is a space between each system when the system is aligned next to another same system. Such a system is very distinct and unique to communicate a system or set on a shelf. The system draws the consumer's attention to the set of complimentary products. A nonlimiting example of this embodiment can be found in Example 6.

In an embodiment of the present invention, a system according to the present invention is provided wherein the indicia follows the shape of the complimentary outer surface contours. A further embodiment of the present invention is wherein the system comprises two or more products comprising the same shape for each product.

An embodiment of the present invention is a system according to present invention wherein each product comprises an asymmetrical shape which forms a symmetrical shape when each product is mutually engageable to other product. A further embodiment is provided wherein each product comprises an asymmetrical shape which forms a circular symmetrical shape when each product is mutually engageable to the other product.

In yet another embodiment, a system according to the present invention comprises a two or more products wherein each product comprises complimentary outer surface contours comprising angled lines which form a continuous sense of motion or a circular sense of motion.

In a further embodiment, a system of the present invention comprise two or more products, each product comprising complimentary outer surface contours, and are not a mirror image of each other. Another embodiment of the present invention comprises a system wherein each product is made of the same material, with a further embodiment comprising a system wherein the indicia are a different color than each product.

A further embodiment of the present invention comprises a system having two or more products wherein each product comprises complimentary outer surface contours forms a shape other than a rectangle.

Efficacy

A further embodiment of the present invention is directed to a system comprising two or more products wherein each product comprises complimentary outer surface contours so as to be mutually engagable in intimate contact to the other product and wherein each product comprises an indicia that extends across each product and communicates that the products are a system and further wherein the efficacy of the products and/or the efficacy of the system is increased wherein the products are used together.

A nonlimiting example of this embodiment is the treatment of dandruff using a system of an antidandruff shampoo with an antidandruff conditioner. Dandruff is a chronic scalp condition caused by sebum, Malassezia and individual susceptibility. Treatment with anti-dandruff shampoos that deposit pyrithione zinc (PTZ) provide an effective method of treatment. Patient habits of using non antidandruff shampoos or non PTZ containing conditioners after treatment may reduce levels of deposited PTZ and resultant efficacy. Clinical studies have demonstrated that antidandruff efficacy and antifungal reductions correlate with the amount of active ingredient (PTZ) deposited onto the scalp from the shampoo (Bailey, P., C. Arrowsmith, K. Darling, J. Dexter, J. Eklund, A. Lane, C. Little, B. Murrary, A. Scott, A. Williams, and D. Wilson. 2003. A double-blind randomizated vehicle-controlled clinical trial investigating the effect of ZnPTO dose on the scalp vs. antidandruff efficacy and antimycotic activity. Intern.l J Cos Sci. 25:183-188.)

A human study was conducted measuring the PTZ deposition of patients using a PTZ containing shampoo followed by use of PTZ containing conditioner versus a PTZ containing shampoo and a non PTZ containing conditioner. The objective of the study was to measure the deposition and retention of either a platelet PTZ containing conditioner or a non PTZ containing conditioner in combination with a PTZ containing shampoo on the human scalp.

Method

Overview: 43 Subjects were recruited for this study (27 male/16 Female)-all undergoing a 1 week preconditioning period using a clarifying shampoo. On Day 1 (post preconditioning) all panelists underwent sampling to verify that no PTZ was present on the scalp. The panelists then underwent 2 consecutive days of treatment with PTZ containing shampoo and PTZ containing conditioner or PTZ containing shampoo and non PTZ containing conditioner. Subjects were then sampled for amount of PTZ found on scalp. In addition Confocal Laser Microscopy was performed to visually demonstrate PTZ deposition on the scalp.

Wash Methodology: The subjects hair is wetted for 30-60 seconds with 95° F. water (1.5 gpm) 10 grams of shampoo product is applied to hair and lathered for 60 seconds. The hair is rinsed for 30-120 seconds until all visible lather is removed. 10 grams of conditioner product is applied to hair and effectively spread throughout hair for 60 seconds (note control leg of study does not include conditioner addition). The hair is rinsed for 30-120 seconds till all visible lather removed. The hair is blow dryed and the scalp is sampled (below) for PTZ deposition.

Sampling Methodology: The hair is parted to reveal scalp surface. A sample cylinder is pressed against the scalp to prevent leakage of extraction fluid. 1 ml of extraction fluid is applied to the cylinder and is scrubed with moderate pressure using a glass rod. The sample fluid is removed and the procedure is repeated combining both aliquots of extraction fluid. The PTZ samples are then analyzed using HPLC.

Confocal Laser Microscopy: The subjects follow the wash protocol described above for shampoo and conditioner products. An imaging fluid is applied to the scalp and a Vivascope 1500 (Lucid Inc.) is used to capture laser confocal images following each product treatment. The same subjects are used for each of the 3 product treatments. Subjects wash with a clarifying shampoo between test products to remove PTZ deposited from the previous treatment. Confocal images are captured following clarifying shampoo usage to ensure complete removal of PTZ prior the next treatment regiment.

The results indicate the use of a non PTZ containing conditioner versus a PTZ conditioner after shampooing with a PTZ containing shampoo significantly reduce the overall amount of PTZ deposited on the scalp and therefore reduced antidandruff efficacy.

PTZ Deposition

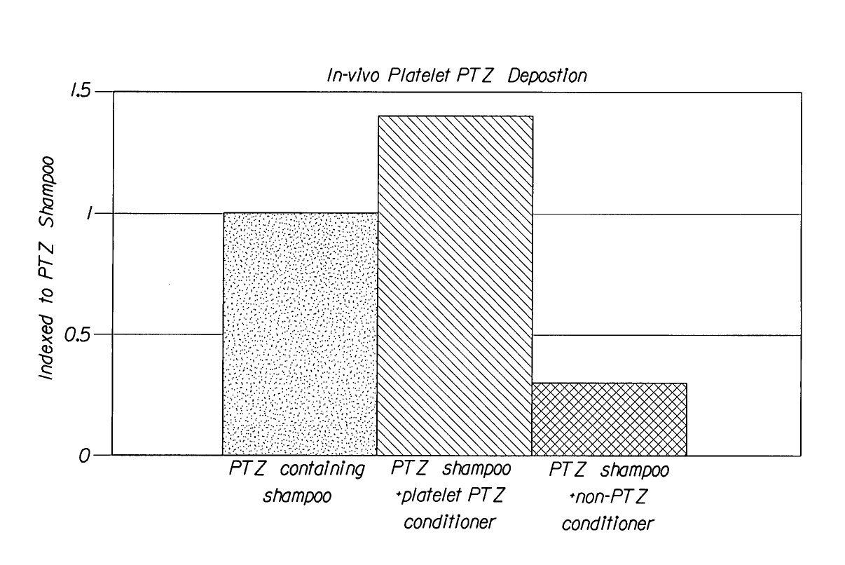

The graph in FIG. 1 demonstrates the use of a PTZ containing shampoo, the use of a PTZ shampoo plus a platelet PTZ conditioner, and the use of a PTZ shampoo plus a non-PTZ conditioner as indexed to a PTZ shampoo.

The graph in FIG. 1 demonstrates that use of a PTZ shampoo +Non PTZ containing conditioner removes significant amounts (70%) of PTZ versus PTZ containing shampoo+PTZ containing conditioner. Further, PTZ shampoo+PTZ conditioner may provide incremental antidandruff protection versus using PTZ containing shampoo alone. The confocal images of PTZ on the scalp showed decreased deposition when using non-PTZ conditioner. The confocal images showed increased PTZ deposition when using a PTZ containing conditioner.

Therefore, the present invention can provide a system which can provide an efficacious system for antidandruff shampoo comprising PTZ. As mentioned above, the use of a PTZ shampoo +Non PTZ containing conditioner removes significant amounts (70%) of PTZ versus PTZ containing shampoo +PTZ containing conditioner. However, the present invention provides a system wherein the consumer is signaled to purchase both a PTZ antidandruff shampoo with a PTZ antidandruff conditioner. Further, according to the data above, PTZ shampoo +PTZ conditioner may provide incremental antidandruff protection versus using PTZ containing shampoo alone. Therefore, the present invention can provide a system for a PTZ antidandruff shampoo with a PTZ antidandruff conditioner, wherein a consumer may be provided with an incremental antidandruff protection versus using PTZ containing shampoo alone.

In a further embodiment of the present invention, a system comprising two or more products wherein each product comprises complimentary outer surface contours which are mutually engagable in intimate contact to the other product and wherein each product comprises an indicia that extends across each product and communicates that the products are a system, further wherein the efficacy of the two or more products is increased when the products are used together when compared to using one of the products.

In a further embodiment, a system according to present invention wherein the complimentary outer surfactant contours of two or more products and indicia which extend across 2 or more products may communicate a dual benefit of the system of two or more products. A nonlimiting example of a dual benefit of the system of two or more products would be an antidandruff benefit and a cosmetic hair benefit.

### EXAMPLES

The following examples illustrate a system comprising two or more products wherein each product comprises complimentary outer surface contours which are mutually engagable in intimate contact to the other product and wherein each product comprises an indicia that extends across each product and communicates that the products are a system. These examples, however, are not intended to be limiting thereof.

Example 1 is a nonlimting example of a front elevational view of a system comprising two products wherein each product comprises complimentary outer surface contours 2 which are mutually engagable in intimate contact to the other product. A cap 1 is also shown.

Example 2 is a nonlimiting example of a front elevational view of a system comprising two products wherein each product comprises complimentary outer surface contours 2 which are mutually engagable in intimate contact to the other product and wherein each product comprises an indicia 3 that extends across each product and communicates that the products are a system. A cap 1 is also shown.

Example 3 is a nonlimiting example of a front elevational view of a system comprising two products wherein each product comprises complimentary outer surface contours 2 which are mutually engagable in intimate contact to the other product and wherein each product comprises an indicia 3 that extends across each product and communicates that the products are a system. A cap 1 is also shown.

Example 4 is a nonlimiting example of a front elevational view a system comprising two products wherein each product comprises complimentary outer surface contours 2 which are mutually engagable in intimate contact to the other product and wherein each product comprises an indicia 3 that extends across each product and communicates that the products are a system. A cap 1 is also shown.

Example 5 is a nonlimiting example of a front elevational view of a system comprising two products wherein each product comprises complimentary outer surface contours 2 which are mutually engagable in intimate contact to the other product and wherein each product comprises an indicia 3 that extends across each product and communicates that the products are a system and further wherein one of the products is inverted. A cap 1 is also shown.

Example 6 is a nonlimiting example of a front elevational view of two systems wherein the complimentary outer surface contours of the products is discontinuous and further wherein there is a space between each system when the system is aligned next to another same system. The example further shows an indicia 3 and a cap 1.

[image]

[image]

[image]

[image]

[image]

[image]

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm”is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system comprising two or more products wherein each product comprises complimentary outer surface contours which are mutually engagable in intimate contact to the other product and wherein each product comprises an indicia that extends across each product and communicates that the products are a system.

2. A system according to claim 1 wherein the efficacy of the system comprising two or more products is increased when the products are used together.

3. A system according to claim 1 wherein the efficacy of the two or more products is increased when the products are used together when compared to using one of the products.

4. A system according to claim 1 wherein the indicia which extend across two or more products communicates a version of the system of two or more products.

5. A system according to claim 1 wherein the indicia which extends across two or more products communicates an end benefit of the system of two or more products.

6. A system according to claim 1 wherein the complimentary outer surfactant contours of two or more products and indicia which extend across two or more products communicate a dual benefit of the system of two or more products.

7. A system according to claim 1 wherein the indicia is selected from the group consisting of complimentary labels, continual labels, sequential labels, adjoining labels, and mixtures thereof.

8. A system according to claim 7 wherein the indicia is a complimentary label.

9. A system according to claim 1 wherein the complimentary outer surface contours form a circular shape.

10. A system according to claim 1 wherein the complimentary outer surface contours of the products is discontinuous.

11. A system according to claim 1 wherein the complimentary outer surface contours of the products is discontinuous and further wherein there is a space between each system when the system is aligned next to another same system.

12. A system according to claim 1 wherein the indicia follows the shape of the complimentary outer surface contours.

13. A system according to claim 1 wherein the indicia follows the curve of the complimentary outer surface contours.

14. A system according to claim 1 wherein the two or more products comprise the same shape for each product.

15. A system according to claim 1 wherein each product comprises an asymmetrical shape which forms a symmetrical shape when each product is mutually engageable to other product.

16. A system according to claim 15 wherein each product comprises an asymmetrical shape which forms a circular symmetrical shape when each product is mutually engageable to the other product.

17. A system according to claim 1 wherein the complimentary outer surface contours form a straight line between the each product to form a third shape.

18. A system according to claim 1 wherein the system comprising two or more products wherein each product comprises complimentary outer surface contours comprises angled lines form a continuous sense of motion.

19. A system according to claim 1 wherein the two or more products, each product comprising complimentary outer surface contours, are not a mirror image of each other.

20. A system according to claim 1 wherein each product is made of the same material.

21. A system according to claim 1 wherein the indicia are a different color than each product.

22. A system according to claim 2 wherein the efficacy of the system of two or products the products is increased when the products are used together and wherein the efficacy is antidandruff efficacy.

23. A system according to claim 3 wherein the efficacy of the two or more products is increased when the products are used together when compared to using one of the products and wherein the efficacy is antidandruff efficacy.

24. A system according to claim 1 wherein the system comprising two or more products wherein each product comprises complimentary outer surface contours forms a shape other than a rectangle.

25. A system according to claim 1 wherein the outer surface contours of the products are complimentary when one of the products is inverted.
